(19) United States
(12) Patent Application Publication
(10) Pub. No.: US 2024/0202624 A1
(43) Pub. Date: Jun. 20, 2024

(54) EVALUATION PARKING SYSTEM AND METHODS

(71) Applicant: NICE LTD., Ra'anana (IL)

(72) Inventors: LeAnn HOPKINS, Lake Worth/Wellington, TX (US); Prasad PATIL, Pune (IN); Rahul VYAS, Jodhpur (IN)

(21) Appl. No.: 18/068,154

(22) Filed: Dec. 19, 2022

(51) Int. Cl. G06Q 10/0631

(52) U.S. Cl. CPC G06Q 10/063116; G06Q 2240/00

(57) ABSTRACT

Evaluation parking systems and methods, and non-transitory computer readable media, including determining that an evaluator is on leave; based on evaluation tasks assigned to the evaluator, retrieving evaluation tasks selected by the evaluator for reassignment, or reading a parking configuration and determining that evaluation tasks meet a criteria of the parking configuration; parking the retrieved evaluation tasks and/or the determined evaluation tasks to an interaction sample segment datastore; obtaining the parked evaluation tasks; and reassigning the obtained parked evaluation tasks in an evaluation task assignment datastore.

### COPYRIGHT NOTICE

A portion of the disclosure of this patent document contains material which is subject to copyright protection. The copyright owner has no objection to the facsimile reproduction by anyone of the patent document or the patent disclosure, as it appears in the U.S. Patent and Trademark Office patent file or records, but otherwise reserves all copyright rights whatsoever.

### TECHNICAL FIELD

The present disclosure relates generally to methods and systems of updating evaluation assignments when an evaluator is on leave, and more particularly to methods and systems that reassign evaluation assignments to available evaluators to ensure that evaluation assignments are timely completed.

### BACKGROUND

In a contact center, agent interactions are periodically evaluated as part of quality management. Quality management is the process of ensuring agent interactions meet a defined quality standard within all channels and across all agents.

Typically, when an evaluator takes unplanned leave, there is no way the interaction distribution system can meaningfully reassign the evaluator's tasks to other evaluators. Consequently, important tasks may expire without evaluation. If an evaluator is taking unplanned or emergency leave, then he/she may want to directly assign his/her important tasks to the other evaluators, which could lead to interpersonal conflicts within a team.

Accordingly, a need exists for improved systems and methods that ensure that evaluation tasks are completed in a timely manner without any conflicts.

### BRIEF DESCRIPTION OF THE DRAWINGS

The present disclosure is best understood from the following detailed description when read with the accompanying figures. It is emphasized that, in accordance with the standard practice in the industry, various features are not drawn to scale. In fact, the dimensions of the various features may be arbitrarily increased or reduced for clarity of discussion.

FIG. 1 is a simplified diagram of one system according to embodiments of the present disclosure.

FIG. 2 is a simplified diagram of another system according to embodiments of the present disclosure.

FIG. 3 is a flowchart of a method according to embodiments of the present disclosure.

FIG. 4 is a screenshot of evaluation tasks selected by an evaluator according to embodiments of the present disclosure.

FIG. 5 is a screenshot of a system notifying the evaluator that the selected evaluation tasks have been parked to the system according to embodiments of the present disclosure.

FIG. 6 is a screenshot of a supervisor or manager configuring a parking request according to embodiments of the present disclosure.

FIG. 7 is a block diagram of a computer system suitable for implementing one or more components in FIG. 1 or FIG. 2 according to one embodiment of the present disclosure.

### DETAILED DESCRIPTION

This description and the accompanying drawings that illustrate aspects, embodiments, implementations, or applications should not be taken as limiting—the claims define the protected invention. Various mechanical, compositional, structural, electrical, and operational changes may be made without departing from the spirit and scope of this description and the claims. In some instances, well-known circuits, structures, or techniques have not been shown or described in detail as these are known to one of ordinary skill in the art.

In this description, specific details are set forth describing some embodiments consistent with the present disclosure. Numerous specific details are set forth in order to provide a thorough understanding of the embodiments. It will be apparent, however, to one of ordinary skill in the art that some embodiments may be practiced without some or all of these specific details. The specific embodiments disclosed herein are meant to be illustrative but not limiting. One of ordinary skill in the art may realize other elements that, although not specifically described here, are within the scope and the spirit of this disclosure. In addition, to avoid unnecessary repetition, one or more features shown and described in association with one embodiment may be incorporated into other embodiments unless specifically described otherwise or if the one or more features would make an embodiment non-functional.

The present systems and methods introduce an evaluation parking system. In certain embodiments, an evaluator is able to park his/her important evaluation tasks back to an interaction distribution system when he/she needs to go on emergency leave. By “evaluation tasks” is meant agent interactions that need to be examined and evaluated to determine whether the agent meets a defined quality standard. The interaction distribution system picks up the pending evaluation tasks of the evaluator who is on leave and reassigns them to available evaluators if required.

In some embodiments, a quality plan can be configured that automatically determines how to assign the evaluation tasks of an evaluator who is on leave to another evaluator who is available. A quality plan is a tool for quality assurance. It samples random interactions based on filters a manager or supervisor defines and sends those interactions to evaluators for review. A manager or supervisor can define which agents to sample, what time period to sample from, the interaction details, and to which evaluators to send proposed interactions.

In an exemplary embodiment, the present methods include receiving a list of evaluation tasks manually or by reading a parking configuration, parking the evaluation tasks, and assigning parked evaluation tasks to available evaluators. The evaluation parking system can be used in either classical mode or dynamic mode as described below.

In the classical mode, an evaluator selects his/her evaluation tasks that need to be reassigned to another evaluator when he/she is taking emergency leave. In the next distribution run, the evaluation parking system takes care of selected evaluation tasks and redistributes them to other evaluators based on the quality plan and which evaluators are available to ensure timely completion of the tasks without any conflicts. Once the evaluator is determined to be on emergency leave, the interaction distribution system stops distributing evaluation tasks to the evaluator immediately and begins redistributing the selected evaluation tasks.

In the dynamic mode, the evaluation parking system is used to fetch evaluation tasks for those evaluators who are on unplanned leave and have not returned from leave. If their evaluation tasks will expire in the next “X” number of days (where X is configurable) or some other threshold expiration period, then the interaction distribution system pulls those evaluation tasks back to the queue and redistributes them to the remaining evaluators. Once an evaluator is determined to be on leave, the interaction distribution system stops distributing evaluation tasks to the evaluator immediately.

Advantageously, the present system and methods may advantageously permit agents to be timely evaluated for the interactions they handle, which increases the benefits of prompt evaluations and feedback and avoids the problem of receiving delayed evaluations. In addition, timely evaluation of agent interactions with contacts results in timely assignment of relevant training programs for agents who need training. Moreover, the evaluation parking system helps ensure that no evaluation tasks expire, and that all evaluation tasks can be timely completed. The evaluation parking system ensures assigned evaluations are reassigned when the original evaluator is unexpectedly out. The system and methods herein advantageously also permit evaluations to be redistributed when an assigned evaluator is overloaded with assignments. Expiration of evaluation tasks or failure to complete evaluation tasks can result in loss of revenue and/or dissatisfied customers for the contact center. Furthermore, pay for performance is not impacted due to agents not receiving an even number of evaluations. The evaluation parking system resolves interpersonal conflicts within the evaluators in a team by automatically assigning evaluation tasks to available evaluators, or by permitting a manager to more easily assign those tasks based on predefined criteria. Lastly, in cases where a business process outsourcing (BPO) company is held accountable to an evaluation count as part of its statement of work (SOW), reassigning ensures penalties are not charged to not meeting the evaluation count goal.

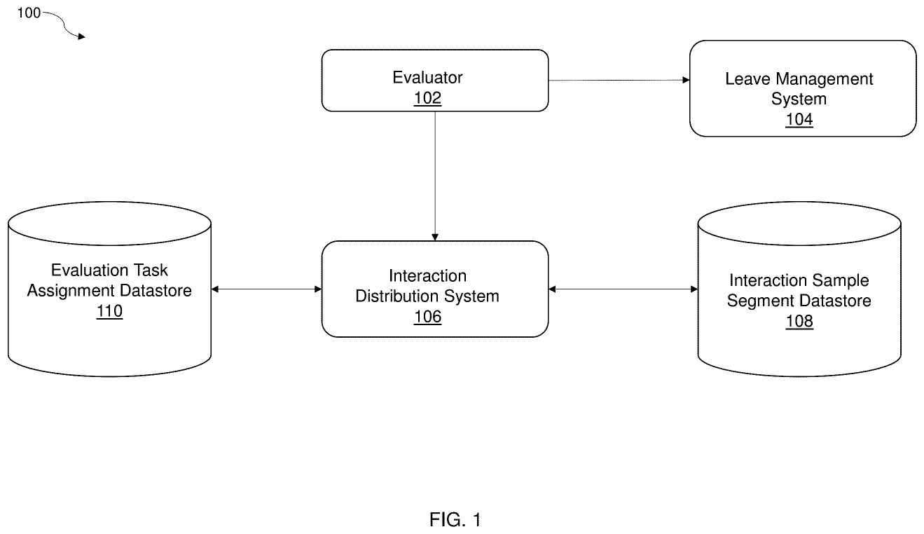

FIG. 1 illustrates a block diagram of a system 100 according to the classical mode of the present disclosure. System 100 includes Evaluator 102, Leave Management System 104, Interaction Distribution System 106, Interaction Sample Segment Datastore 108, and Evaluation Task Assignment Datastore 110. In various embodiments, Evaluator 102 is planning on taking leave. Evaluator 102 selects and sends a list of evaluation tasks to Interaction Distribution System 106 and updates his/her leave information with Leave Management System 104. Leave Management System 104 keeps track of employee leave status for a specific duration.

According to one or more embodiments, Interaction Distribution System 106 is a specialized system that is also known as a quality planner tool or application software that helps in distributing agent interactions to a list of evaluators based on defined filter criteria. In some embodiments, a manager can create a quality plan where the manager selects filters for distributing agent recordings based on various factors such as the call length of the agent recording and/or a type of channel (e.g., voice, chat, email, or any digital channel). After defining the filter criteria, a manager can select a group of agents, a duration of recorded interactions that will be distributed, and the list of evaluators to which the recorded interactions will be distributed. Interaction Distribution System 106 ensures timely assignment of evaluation tasks to evaluators.

In various embodiments, Interaction Distribution System 106 is used to distribute call segments across evaluators per the configuration of the quality plan. The scheduled job runs as per the configurable duty cycle, and distributes the call segments evenly among all evaluators. Whenever a manager creates a new quality plan, Interaction Distribution System 106 calls Microsoft Container Registry (MCR) Search Microservice, which will query an elastic search to get the segment records per the date range in the quality plan. Once the agent segments are retrieved from the elastic search, the segments are inserted into Interaction Sample Segment Datastore 108.

In some embodiments, Interaction Distribution System 106 receives the current assignment of the evaluation tasks from Evaluation Task Assignment Datastore 110. Table 1 below is an example of current assignment data stored in Evaluation Task Assignment Datastore 110.

TABLE 1
CURRENT ASSIGNMENTS

| Plan | | | | Evaluator |
|---|---|---|---|---|
| Occurrence ID | Evaluator ID | Segment ID | Agent ID | Status |
| P1 | E1 | S1 | A1 | Available |
| P1 | E2 | S2 | A2 | Available |
| P1 | E3 | NULL | NULL | Available |

The plan occurrence ID is the unique ID for the quality plan created by the manager or supervisor. The evaluator ID is the unique identifier for the evaluators. The segment ID denotes the call segment handled between the agent and the customer. The agent ID denotes the unique agent ID of the agent in the call segment. The evaluator status indicates whether evaluators are available or not.

Interaction Distribution System 106 parks the evaluation tasks from Evaluation Assignment Datastore 110 to Interaction Sample Segment Datastore 108 as shown below in Table 2.

TABLE 2
PARKED EVALUATION TASKS

| Plan | | | Segment |
|---|---|---|---|
| Occurrence ID | Segment ID | Agent ID | Start Time |
| P1 | S1 | A1 | T1 |
| P1 | S2 | A2 | T2 |

Plan occurrence ID is a unique ID for the quality plan created by the manager or supervisor. Segment ID denotes the call segment handled between the agent and the customer. Agent ID denotes the agent involved in the call segment. Segment start time denotes the time when the agent handled the given call segment.

In the next distribution cycle, Interaction Distribution System 106 retrieves the parked evaluation tasks from Interaction Sample Segment Datastore 108, and assigns the evaluation tasks evenly to available evaluators. Such evaluation tasks are assigned to the evaluators by inserting the relevant entry to Evaluation Task Assignment Datastore 110.

In certain embodiments, Interaction Distribution System 106 also updates the evaluation assignment and evaluator status in Evaluation Task Assignment Datastore 110 as shown in Table 3.

TABLE 3
UPDATED EVALATION ASSIGNMENTS
AND EVALUATOR STATUS

| Plan | | | | Evaluator |
|---|---|---|---|---|
| Occurrence ID | Evaluator ID | Segment ID | Agent ID | Status |
| P1 | E1 | S1 | A1 | Available |
| P1 | E2 | NULL | NULL | On Leave |
| P1 | E3 | S2 | A2 | Available |

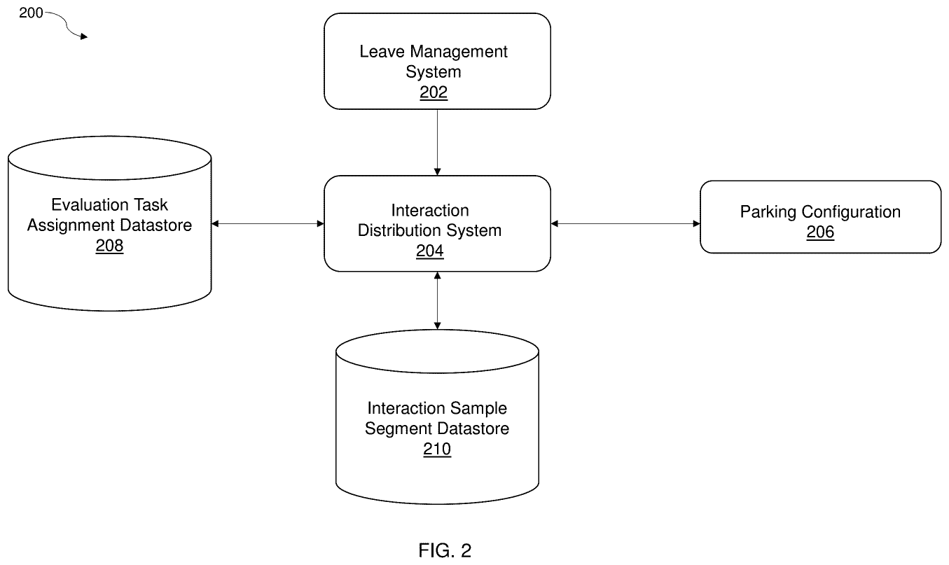

FIG. 2 illustrates a block diagram of a system 200 according to the dynamic mode of the present disclosure. System 200 includes Leave Management System 202, Interaction Distribution System 204, Parking Configuration 206, Evaluation Task Assignment Datastore 208, and Interaction Sample Segment Datastore 210. In this embodiment, whenever an evaluator is going on leave, Leave Management System 202 sends employee leave status to Interaction Distribution System 204 for the evaluator taking emergency or unplanned leave, and the evaluator's status is updated. Interaction Distribution System 204 retrieves the list of evaluation tasks assigned to the evaluator by requesting and reading Parking Configuration 206. A manager or supervisor can configure a parking request before creating a quality plan so that when an evaluator is on leave, he/she does not receive any evaluation tasks, and the evaluation tasks are sent back to (or retained in) the queue. In several embodiments, the parking request can be configured to auto-park the evaluation task if the task has not been worked on within “X” number of days (where X is configurable), allow the evaluator to manually send an evaluation task to be parked, or auto-park an evaluation task if Leave Management System 202 indicates the assigned evaluator is on unplanned or planned leave.

After reading Parking Configuration 206, Interaction Distribution System 204 determines whether the criteria for parking the evaluation tasks have been satisfied. If the criteria are met, Interaction Distribution System 206 receives the current evaluation assignments for the evaluation tasks from Evaluation Task Assignment Datastore 208.

The evaluation tasks are then parked to Interaction Sample Segment Datastore 210. Interaction Sample Segment Datastore 210 sends these evaluation tasks to Interaction Distribution System 204 for distribution in the next distribution cycle. Interaction Distribution System 204 subsequently updates the evaluation assignments in Evaluation Task Assignment Datastore 208.

In some embodiments of the dynamic mode, Interaction Distribution System 204 is configured to run in its defined duty cycle. A duty cycle is a time period for which Interaction Distribution System 204 runs periodically. In certain embodiments, Interaction Distribution System 204 iterates over each tenant and selects one tenant. For the one tenant, Interaction Distribution System 204 fetches all the quality plans, and selects one quality plan. The quality plan is configured to run by selecting certain agents and certain evaluators. The evaluators get recorded interactions for evaluation. Interaction Distribution System 204 then checks the evaluator status and their associated tasks. If the evaluator is on leave, then no new tasks are assigned to the evaluator. The Parking Configuration 206 is read for those evaluators who are on leave. If the criteria for parking of evaluation tasks is satisfied, then those evaluation tasks are qualified for parking and are parked to Interaction Sample Segment Datastore 210. Interaction Distribution System 204 then assigns parked evaluation tasks to other evaluators who are available in the quality plan.

Whenever an evaluator is taking unplanned leave, the status of the evaluator is updated inside Leave Management System 202. Leave Management System 202 can trigger notification to Amazon Web Service (AWS) Lambda, and AWS Lambda calls Interaction Distribution System 204 via representational state transfer application programming interface (REST API) to update the evaluator status. Leave Management System 202 can utilize the AWS cloud-based managed service such as Simple Notification System (SNS) and Lambda. These services are managed services in which whenever evaluator leave status information is updated, a trigger event is generated through SNS topic and the relevant AWS Lambda service calls the API of Interaction Distribution System 204 to update the relevant status of the evaluator.

Once the evaluator status is updated to “on leave,” the evaluator will stop receiving any further evaluation tasks from Interaction Distribution System 204. Interaction Distribution System 204 reads the relevant Parking Configuration 206 of the quality plan, and if the relevant criteria is matched, then relevant evaluation tasks are evenly distributed among available evaluators.

In one or more embodiments, the lifecycle of the dynamic mode is divided into the preparations phase, the data collection phase, and the parking phase. In the preparations phase, all the tenants are obtained and a single tenant is selected. Then all the quality plans of the single tenant are obtained, and a single quality plan is selected. In the data collection phase, the status of the evaluators is obtained, and the Parking Configuration 206 for the single quality plan is obtained. In some embodiments, an accumulator fetches the status of evaluators and the metadata of their associated tasks. In various embodiments, an analyzer analyzes the evaluator progress on assigned tasks and checks the priority of tasks. In the parking phase, the Parking Configuration 206 is processed, and the Evaluation Task Assignment Datastore 208 is updated.

The entire lifecycle process can be run and scheduled via a cron-jon application or other application, such as per the following example.

@Scheduled(cron=“${qp.distribution.schedule.cron}”)
synchronized void scheduleAutoParking( ) {
startParkingProcess ( );
}

The@Scheduled annotation is used to trigger the scheduler for a specific time period, the qp.distribution.schedule.cron can be kept inside the configuration file, which will define the time period after which the same process should be repeated.

The following is a sample cron expression that shows how to execute the task every minute starting at 9:00 AM and ending at 9:59 AM, every day, i.e., for a duty cycle of one hour.

qp.distribution.schedule.cron=“0*9**?”

### Preparation Phase

All the tenants are obtained, and one tenant is picked. The relevant REST API is called to get all tenant IDs available for a given business unit.

The API format can be of as follows:
REST END POINT:—GET {domainUrl}/tenants
Request Payload:—{status: “ACTIVE”}
Response Object:—{tenants: [{tenantId: 1, name: NICE}, {tenantId: 2, name: IBM}]}

As shown above, the rest end-point is called with a request payload in which all the active tenants list is being fetched. The response provides a list of tenants object. From here, the process is iterated over each tenant, and one tenant is selected for each scheduled time.

Next, all the active quality plans are obtained, and a single quality plan is selected. The quality plan is created by the manager or supervisor. When a single tenant is selected, all the active quality plans for that tenant are picked. The active quality plans and relevant parking configurations can be saved inside a table-oriented database as shown below.

TABLE 4
QUALITY PLAN INFORMATION

| Plan | Plan | Parking | | Plan Occurrence |
|---|---|---|---|---|
| ID | Name | Configuration | Plan Evaluators | Period |
| 1 | Plan A | Object | [{E1: ‘ACTIVE’, | Monthly |
| | | | E2: ‘LEAVE’}] | |
| 2 | Plan B | Object | [{E3: ‘ACTIVE’, | Weekly |
| | | | E4: ‘LEAVE’}] | |
| 3 | Plan C | Object | [{E5: ‘ACTIVE’, | One time plan |
| | | | E6: ‘LEAVE’}] | |

The active quality plan information shown above belongs to a given tenant schema so querying the database with a select operation will yield all the active quality plans saved for the given tenant. The parking configuration can be configured as an object for the given quality plan.

The plan occurrence period defines the recurring time in which the one occurrence will be running and after the plan period expires, then a new occurrence of the plan will begin. A recurring plan such as monthly or weekly will get a new occurrence of the quality plan every week or month. A one-time plan is a plan that has a certain date range and once the respective end date is reached, the plan is completed. No new occurrence of the plan is created.

### Data Collection Phase

First, the evaluator status is obtained. In some embodiments, whenever an evaluator is going on leave, Leave Management System 202 sends the evaluator status to Interaction Distribution System 204, and the status of the evaluator is updated inside a table-oriented database.

TABLE 5
EVALUATOR STATUS

| Evaluator ID | Evaluator Name | Status |
|---|---|---|
| 1 | Jim | Active |
| 2 | Bob | On Leave |
| 3 | Sally | Active |

From the single quality plan selected in the preparation phase, the evaluators in the quality plan are now obtained, and the status of all the evaluators is compared with the evaluator status table. If a change is found in the status, then the update query is run against the plan information table to update the plan evaluator status.

After updating the status of the plan evaluators, the relevant plan Parking Configuration 206 is read. Parking Configuration 206 can be stored as a complex object such as a JavaScript Objection Notation (JSON) format. Parking Configuration 206 is helpful in parking of evaluation tasks.

An example of Parking Configuration 206 in JSON format is as follows:

{
plan id”: “x”,
“parking configuration”: {
“Evaluator is on leave”: “true”,
“Evaluator tasks not actioned within”: “2 days”,
“Auto park interaction when task expired after”: “3 days”
}
}

The agent recording or interaction metadata can be stored inside an elastic search as a document-oriented database that utilizes the JSON format. Interaction metadata is stored as a complex object. The object may hold lists of information, such as different business data strings. Example of interaction metadata include interaction ID, local start time, local stop time, GMT start time, GMT stop time, interaction duration, open reason, close reason, switch ID, user ID, interaction type, media type, dialed number (ANI), participants, contact ID, contact start time, or call ID. In some embodiments, evaluation tasks are stored in an Structured Query Language (SQL) database.

### Parking Phase

In this phase, Parking Configuration 206 is read and if any one of the criteria is matched, then the relevant evaluation tasks are parked. Evaluation Task Assignment Datastore 208 is also updated with new assignments.

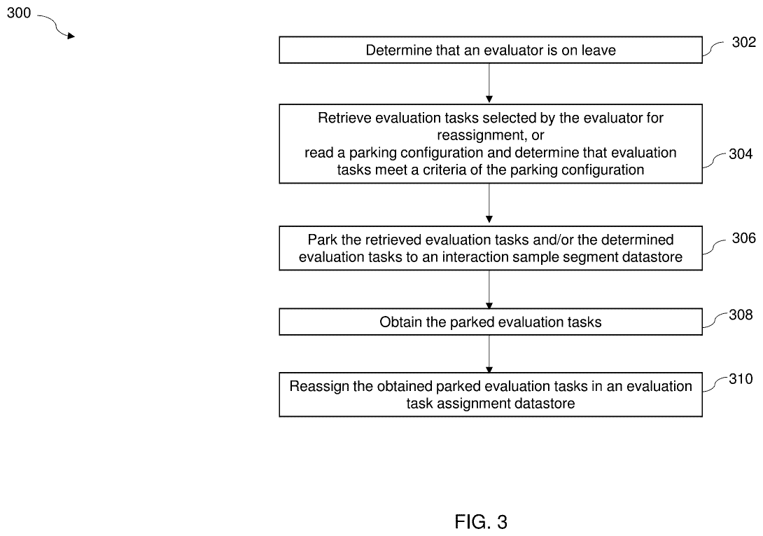

Referring now to FIG. 3, a method 300 according to embodiments of the present disclosure is described. At step 302, Interaction Distribution System 106, 204 determines that an evaluator is on leave. In one embodiment, Interaction Distribution System 204 receives from Leave Management System 202 evaluator status information of the evaluator, and Interaction Distribution System 204 updates an evaluator status of the evaluator. In another embodiment, Interaction Distribution System 106 receives evaluation tasks from Evaluator 102, and is notified that Evaluator 102 is on leave. In some embodiments, Interaction Distribution System 106, 204 terminates assignment of evaluation tasks to the evaluator while the evaluator is on leave.

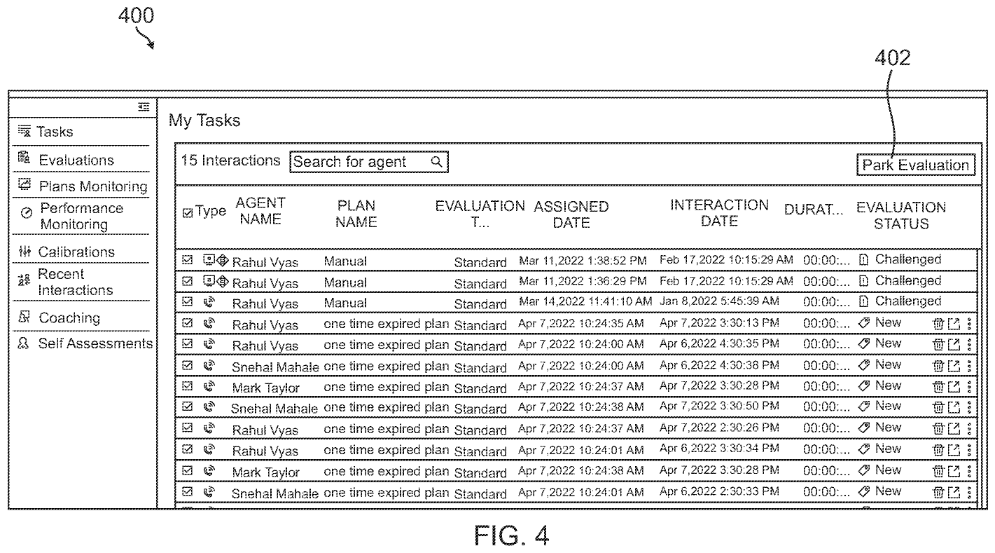

In one embodiment, at step 304, Interaction Distribution System 106 retrieves evaluation tasks selected by Evaluator 102 for reassignment. FIG. 4 illustrates a user interface 400 used by Evaluator 102 to manually park evaluation tasks to Interaction Distribution System 106. If Evaluator 102 is going on leave, then Evaluator 102 can select his/her tasks and click the park evaluation button 402, which will push those tasks back to Interaction Distribution System 106. Interaction Distribution System 106 takes care of assigning those tasks among available evaluators. After clicking the park evaluation button 402, the relevant assignments that were distributed from a given quality plan are assigned back to Interaction Distribution System 106. Now it is the responsibility of Interaction Distribution System 106 to assign those tasks back to available evaluators.

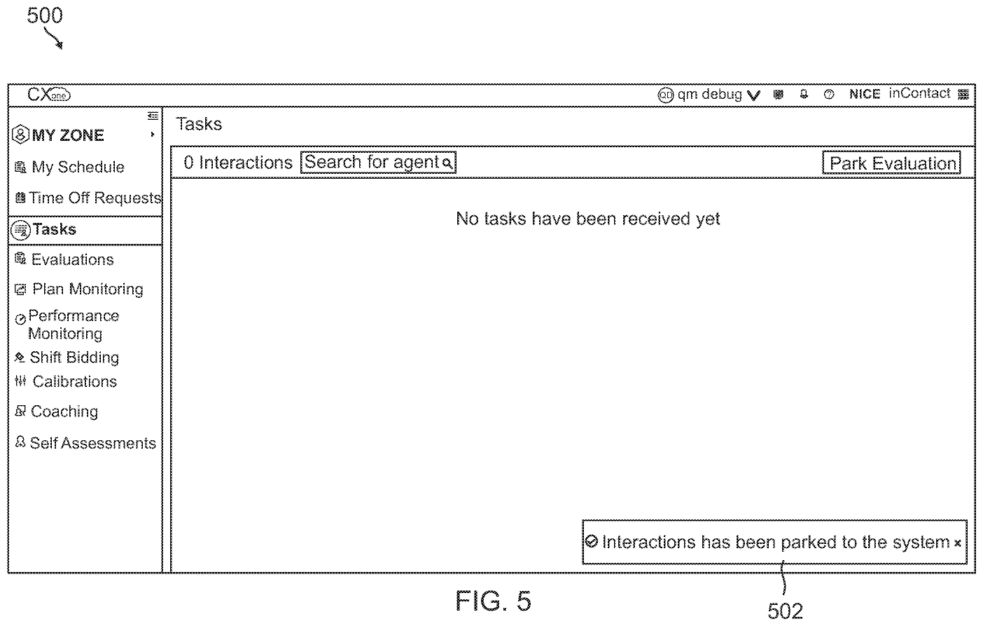

FIG. 5 illustrates a user interface 500 after Evaluator 102 clicks the park evaluation button 402. Once the evaluation tasks are parked, Evaluator 102 receives a successful message 502 stating the relevant evaluation tasks have been parked to the system.

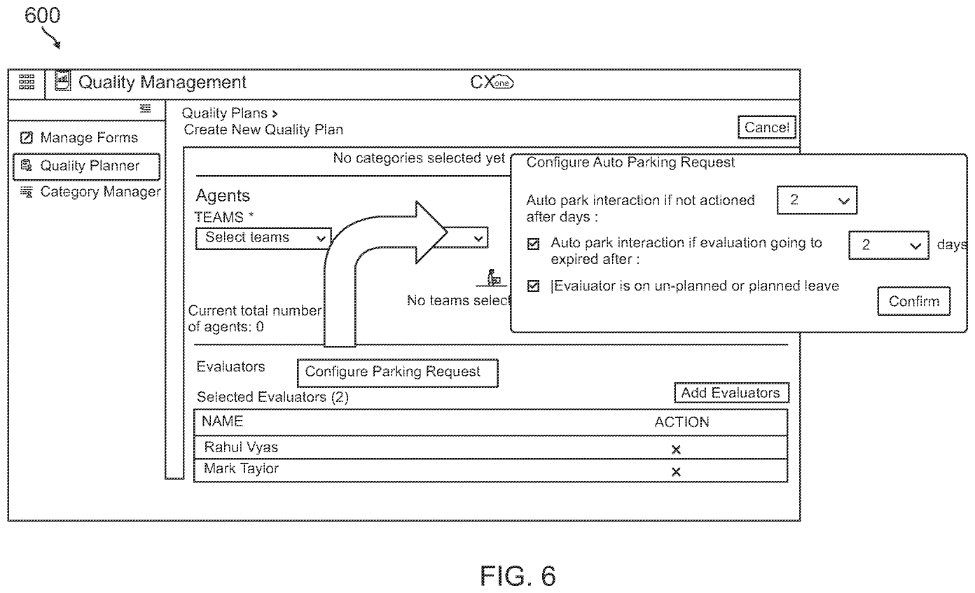

In another embodiment, at step 304, Interaction Distribution System 204 reads a Parking Configuration 206 and determines that evaluation tasks meet a criteria of the Parking configuration 206. FIG. 6 illustrates a user interface 600 for configuring a parking request during creation of a quality plan. Here, a manager or supervisor can configure a parking request before creating a quality plan in such a way that whenever an evaluator is going on leave he/she should not receive any evaluation tasks, and also the important assigned tasks that are still ongoing or incomplete (but still need attention before the evaluator's planned return) should go back to the pool. As shown in FIG. 6, the parking request can be configured as follows: Auto-park a task if the interaction has not been acted on within “X” days, auto-park a task if an evaluation is going to expire in “X” days, or auto-park a task if Leave Management System 202 indicates the assigned evaluator is on unplanned or planned leave. Based on the parking configuration that is read, Interaction Distribution System 204 assigns evaluation tasks to evaluators.

In certain embodiments, within quality plans, the parking configuration provides users with one of the following options: (1) auto-park if the interaction has been actioned within “X” days, where action is defined as evaluated, removed, or requested to replace; (2) manually parked (this allows the evaluator to manually send the interaction to be parked); and (3) auto-park if Leave Management System 104, 202 indicates the assigned evaluator is on unplanned or planned leave.

In several embodiments, Interaction Distribution System 204 determines that evaluation tasks meet the criteria of the Parking Configuration 206 (e.g., an evaluation task has not been evaluated within X days), and Interaction Distribution System 204 fetches evaluation tasks that meet the criteria of the Parking Configuration 206 from Evaluation Task Assignment Datastore 208 before parking the determined evaluation tasks to Interaction Sample Segment Datastore 210. In other embodiments, Interaction Distribution System 204 determines that evaluation tasks meet the criteria of the Parking Configuration 206, and the Parking Configuration 206 includes instructions to automatically park evaluation tasks that have not been acted on in a certain number of days, or have been assigned to an evaluator on leave or expected to still be on leave when further action is next needed on an evaluation task. In yet other embodiments, Interaction Distribution System 204 determines that evaluation tasks meet the criteria of the Parking Configuration 206, and Interaction Distribution System 204 receives from a manager of the evaluator, a quality plan including the Parking Configuration 206.

At step 306, Interaction Distribution System 106, 204 parks the retrieved evaluation tasks and/or the determined evaluation tasks to Interaction Sample Segment Datastore 108, 210. In certain embodiments, Interaction Distribution System 106, 204 is configured to distribute segments of evaluation tasks across evaluators per the quality plan. In some embodiments, Interaction Distribution System 106, 204 is configured to run periodically, and in a subsequent distribution cycle, to park the retrieved evaluation tasks and/or the determined evaluation tasks to Interaction Sample Segment Datastore 108, 210.

In an exemplary embodiment, there are two ways that evaluation tasks can be parked to Interaction Sample Segment Datastore 108, 210. In one scenario where evaluator E2 is taking unplanned leave, and E2 selects assigned segment S2 related to agent A2 for reassignment (as shown in FIG. 1), or Interaction Distribution System 204 gets E2's status and gets the same segment by reading the Parking Configuration 206 (as shown in FIG. 2).

Interaction Distribution System 106, 204 fetches those evaluation tasks from the Evaluation Task Assignment Datastore 110, 208, and such tasks are parked to Interaction Sample Segment Datastore 108, 210. Interaction Distribution System 106, 204 then updates E2's status as “on leave” so that E2 does not receive any new evaluation tasks while E2 is on leave. Interaction Distribution System 106, 204 runs periodically so in the next distribution cycle, the parked evaluation tasks in Interaction Sample Segment Datastore 108, 210 may be distributed to the available evaluators evenly.

At step 308, Interaction Distribution System 106, 204 obtains from Interaction Sample Segment Datastore 108, 210 the parked evaluation tasks.

At step 310, Interaction Distribution System 106, 204 reassigns the obtained parked evaluation tasks in Evaluation Task Assignment Datastore 110, 208. In various embodiments, Interaction Distribution System 106, 204 distributes the reassigned obtained parked evaluation tasks to the available evaluators.

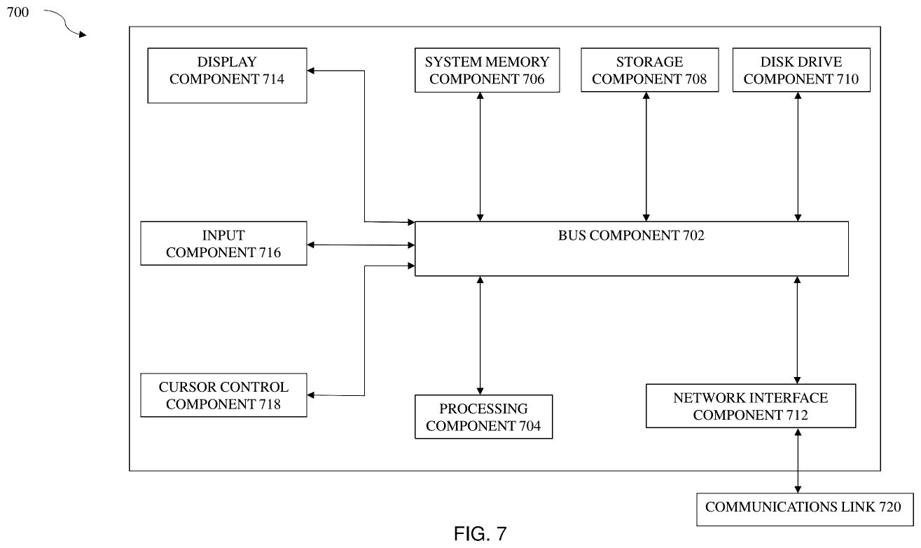

Referring now to FIG. 7, illustrated is a block diagram of a system 700 suitable for implementing embodiments of the present disclosure. System 700, such as part of a computer and/or a network server, includes a bus 702 or other communication mechanism for communicating information, which interconnects subsystems and components, including one or more of a processing component 704 (e.g., processor, micro-controller, digital signal processor (DSP), etc.), a system memory component 706 (e.g., RAM), a static storage component 708 (e.g., ROM), a network interface component 712, a display component 714 (or alternatively, an interface to an external display), an input component 716 (e.g., keypad or keyboard), and a cursor control component 718 (e.g., a mouse pad).

In accordance with embodiments of the present disclosure, system 700 performs specific operations by processor 704 executing one or more sequences of one or more instructions contained in system memory component 706. Such instructions may be read into system memory component 706 from another computer readable medium, such as static storage component 708. These may include instructions to determine, by an interaction distribution system, that an evaluator is on leave; based on evaluation tasks assigned to the evaluator: retrieving, by the interaction distribution system, evaluation tasks selected by the evaluator for reassignment, or read, by the interaction distribution system, a parking configuration and determine, by the interaction distribution system, that evaluation tasks meet a criteria of the parking configuration; parking, by the interaction distribution system, the retrieved evaluation tasks and/or the determined evaluation tasks to an interaction sample segment datastore; obtain, by the interaction distribution system from the interaction sample segment datastore, the parked evaluation tasks; and reassign, by the interaction distribution system to available evaluators, the obtained parked evaluation tasks in an evaluation task assignment datastore. In other embodiments, hard-wired circuitry may be used in place of or in combination with software instructions for implementation of one or more embodiments of the disclosure.

Logic may be encoded in a computer readable medium, which may refer to any medium that participates in providing instructions to processor 704 for execution. Such a medium may take many forms, including but not limited to, non-volatile media, volatile media, and transmission media. In various implementations, volatile media includes dynamic memory, such as system memory component 706, and transmission media includes coaxial cables, copper wire, and fiber optics, including wires that comprise bus 702. Memory may be used to store visual representations of the different options for searching or auto-synchronizing. In one example, transmission media may take the form of acoustic or light waves, such as those generated during radio wave and infrared data communications. Some common forms of computer readable media include, for example, RAM, PROM, EPROM, FLASH-EPROM, any other memory chip or cartridge, carrier wave, or any other medium from which a computer is adapted to read.

In various embodiments of the disclosure, execution of instruction sequences to practice the disclosure may be performed by system 700. In various other embodiments, a plurality of systems 700 coupled by communication link 720 (e.g., LAN, WLAN, PTSN, or various other wired or wireless networks) may perform instruction sequences to practice the disclosure in coordination with one another. Computer system 700 may transmit and receive messages, data, information and instructions, including one or more programs (i.e., application code) through communication link 720 and communication interface 712. Received program code may be executed by processor 704 as received and/or stored in disk drive component 710 or some other non-volatile storage component for execution.

The Abstract at the end of this disclosure is provided to comply with 37 C.F.R. § 1.72(b) to allow a quick determination of the nature of the technical disclosure. It is submitted with the understanding that it will not be used to interpret or limit the scope or meaning of the claims.

What is claimed is:

1. An evaluation parking system comprising:
a processor and a computer readable medium operably coupled thereto, the computer readable medium comprising a plurality of instructions stored in association therewith that are accessible to, and executable by, the processor, to perform operations which comprise:
determining, by an interaction distribution system, that an evaluator is on leave;
based on evaluation tasks assigned to the evaluator:
retrieving, by the interaction distribution system, evaluation tasks selected by the evaluator for reassignment, or
reading, by the interaction distribution system, a parking configuration and determining, by the interaction distribution system, that evaluation tasks meet a criteria of the parking configuration;
parking, by the interaction distribution system, the retrieved evaluation tasks and/or the determined evaluation tasks to an interaction sample segment datastore;
obtaining, by the interaction distribution system from the interaction sample segment datastore, the parked evaluation tasks; and
reassigning, by the interaction distribution system to available evaluators, the obtained parked evaluation tasks in an evaluation task assignment datastore.

2. The evaluation parking system of claim 1, wherein the operations further comprise distributing, by the interaction distribution system, the re-assigned obtained parked evaluation tasks to the available evaluators.

3. The evaluation parking system of claim 1, wherein the operations further comprise terminating, by the interaction distribution system, assignment of evaluation tasks to the evaluator while the evaluator is on leave.

4. The evaluation parking system of claim 1, wherein determining that the evaluator is on leave comprises receiving, by the interaction distribution system from a leave management system, evaluator status information of the evaluator, and the operations further comprise updating an evaluator status of the evaluator.

5. The evaluation parking system of claim 1, wherein the interaction distribution system determines that evaluation tasks meet the criteria of the parking configuration, and the operations further comprise fetching, by the interaction distribution system, the evaluation tasks that meet the criteria of the parking configuration from the evaluation task assignment data store before parking the determined evaluation tasks to the interaction sample segment datastore.

6. The evaluation parking system of claim 1, wherein the interaction distribution system determines that evaluation tasks meet the criteria of the parking configuration, and the parking configuration comprises instructions to automatically park evaluation tasks that (1) have not been acted on in a certain number of days or (2) have been assigned to an evaluator who is on leave.

7. The evaluation parking system of claim 1, wherein the interaction distribution system determines that evaluation tasks meet the criteria of the parking configuration, and the operations further comprise receiving, from a manager of the evaluator, a quality plan comprising the parking configuration.

8. The evaluation parking system of claim 7, wherein the interaction distribution system is configured to distribute segments of evaluation tasks across evaluators per the quality plan.

9. The evaluation parking system of claim 1, wherein the interaction distribution system is configured to run periodically, and in a subsequent distribution cycle, to park the retrieved evaluation tasks and/or the determined evaluation tasks to the interaction sample segment datastore.

10. A method for updating evaluation assignments, which comprises:
determining, by an interaction distribution system, that an evaluator is on leave;
from evaluation tasks assigned to the evaluator:
retrieving, by the interaction distribution system, evaluation tasks selected by the evaluator for reassignment, or
reading, by the interaction distribution system, a parking configuration and determining, by the interaction distribution system, that evaluation tasks meet a criteria of the parking configuration;
parking, by the interaction distribution system, the retrieved evaluation tasks and/or the determined evaluation tasks to an interaction sample segment datastore;
obtaining, by the interaction distribution system from the interaction sample segment datastore, the parked evaluation tasks; and
reassigning, by the interaction distribution system to available evaluators, the obtained parked evaluation tasks in an evaluation task assignment datastore.

11. The method of claim 10, which further comprises distributing, by the interaction distribution system, the re-assigned obtained parked evaluation tasks to the available evaluators.

12. The method of claim 10, which further comprises terminating, by the interaction distribution system, assignment of evaluation tasks to the evaluator while the evaluator is on leave.

13. The method of claim 10, wherein determining that the evaluator is on leave comprises receiving, by the interaction distribution system from a leave management system, evaluator status information of the evaluator, and the method further comprise updating an evaluator status of the evaluator.

14. The method of claim 10, wherein the interaction distribution system determines that evaluation tasks meet the criteria of the parking configuration, and the method further comprises fetching, by the interaction distribution system, the evaluation tasks that meet the criteria of the parking configuration from the evaluation task assignment data store before parking the determined evaluation tasks to the interaction sample segment datastore.

15. The method of claim 10, wherein the interaction distribution system determines that evaluation tasks meet the criteria of the parking configuration, and the parking configuration comprises instructions to automatically park evaluation tasks that (1) have not been acted on in a certain number of days or (2) have been assigned to an evaluator who is on leave.

16. A non-transitory computer-readable medium having stored thereon computer-readable instructions executable by a processor to perform operations which comprise:
determining, by an interaction distribution system, that an evaluator is on leave;
based on evaluation tasks assigned to the evaluator:
retrieving, by the interaction distribution system, evaluation tasks selected by the evaluator for reassignment, or
reading, by the interaction distribution system, a parking configuration and determining, by the interaction distribution system, that evaluation tasks meet a criteria of the parking configuration;
parking, by the interaction distribution system, the retrieved evaluation tasks and/or the determined evaluation tasks to an interaction sample segment datastore;
obtaining, by the interaction distribution system from the interaction sample segment datastore, the parked evaluation tasks; and
reassigning, by the interaction distribution system to available evaluators, the obtained parked evaluation tasks in an evaluation task assignment datastore.

17. The non-transitory computer-readable medium of claim 16, wherein the operations further comprise distributing, by the interaction distribution system, the re-assigned obtained parked evaluation tasks to the available evaluators.

18. The non-transitory computer-readable medium of claim 16, wherein the operations further comprise terminating, by the interaction distribution system, assignment of evaluation tasks to the evaluator while the evaluator is on leave.

19. The non-transitory computer-readable medium of claim 16, wherein determining that the evaluator is on leave comprises receiving, by the interaction distribution system from a leave management system, evaluator status information of the evaluator, and the operations further comprise updating an evaluator status of the evaluator.

20. The non-transitory computer-readable medium of claim 16, wherein the interaction distribution system determines that evaluation tasks meet the criteria of the parking configuration, and the operations further comprise fetching, by the interaction distribution system, the evaluation tasks that meet the criteria of the parking configuration from the evaluation task assignment data store before parking the determined evaluation tasks to the interaction sample segment datastore.
